(19) United States
(12) Patent Application Publication
(10) Pub. No.: US 2008/0016495 A1
(43) Pub. Date: Jan. 17, 2008

(54) WEB ACTIVITY HIGHLIGHTED IN AN IDE ENVIRONMENT

(75) Inventors: Eric L. Barsness, Pine Island, MN (US); John M. Santosuosso, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/457,913

(22) Filed: Jul. 17, 2006

(51) Int. Cl. G06F 9/44

(52) U.S. Cl. 717/124

(57) ABSTRACT

A computer program product stored on machine readable media and including instructions for providing a developer with enhancement information generated from usage information produced by software, includes instructions for: the software storing the usage information as a log file; obtaining the log file including usage information from a network resource; reading the log file; transforming the usage information into the enhancement information; and providing the enhancement information to the developer.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention is related to software development tools, and more particularly to tools for tracking end user applications.

2. Description of the Related Art

It is well known that many software products in use today include a myriad of features. These features provide users with a great deal of versatility. However, there is always room for improvement. That is, some users push software products to the limits of the provided functionality. These power users, as well as other users, may manipulate the software in ways not imagined by the original developers.

For the developers of the complicated software products, it is advantageous to have meaningful feedback regarding the use of their products. More specifically, with the great investments made in such software by developers and users alike, it is frequently advantageous to improve certain portions of a software product as opposed to abandoning the product altogether and starting anew. Therefore, software developers and users would benefit from having good communication with each other regarding aspects of use for any given software product.

Unfortunately, with the level of complexity of the software products, and the subjective perspective of many users, collecting personal interpretations is not always valuable to the developer.

What is needed is a technique for providing an integrated development environment (referred to as an “IDE”) with objective usage information for products developed using the IDE. Preferably, the providing is non-obtrusive and provides detailed information to developers using the IDE.

### SUMMARY OF THE INVENTION

The shortcomings of the prior art are overcome and additional advantages are provided through the provision of a computer program product stored on machine readable media and including instructions for providing a developer with enhancement information generated from usage information produced by software, the instructions including instructions for: the software storing the usage information as a log file; obtaining the log file including usage information from a network resource; reading the log file; transforming the usage information into the enhancement information; and providing the enhancement information to the developer.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer program product stored on machine readable media and including instructions for providing a developer with enhancement information generated from usage information produced by software, the instructions including instructions for: obtaining a log file including usage information from a network resource including a web server by at least one of receiving and retrieving the usage information, by referring to a mapping file that includes instructions for obtaining the usage information; reading the log file; the software storing the usage information as the log file wherein the log file includes at least one of an access log, trace output and application log filea page, a servlet file, an action class and wherein the software includes components of the computer program product for producing the usage information; transforming the usage information by at least one of analyzing, qualifying, characterizing, prioritizing, grouping and displaying the usage information into the enhancement information and performing at least one of data grouping, assessment and presentation of the usage information; and providing the enhancement information to the developer; wherein the enhancement information includes information regarding at least one of paths taken; options used; notice of errors and warnings; priority information and information regarding how the software is being used; wherein the computer program product includes at least one of a plug-in, a feature, and a separate program.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of an architecture for providing usage information.

The detailed description explains the preferred embodiments of the invention, together with advantages and features, by way of example with reference to the drawings.

### DETAILED DESCRIPTION OF THE INVENTION

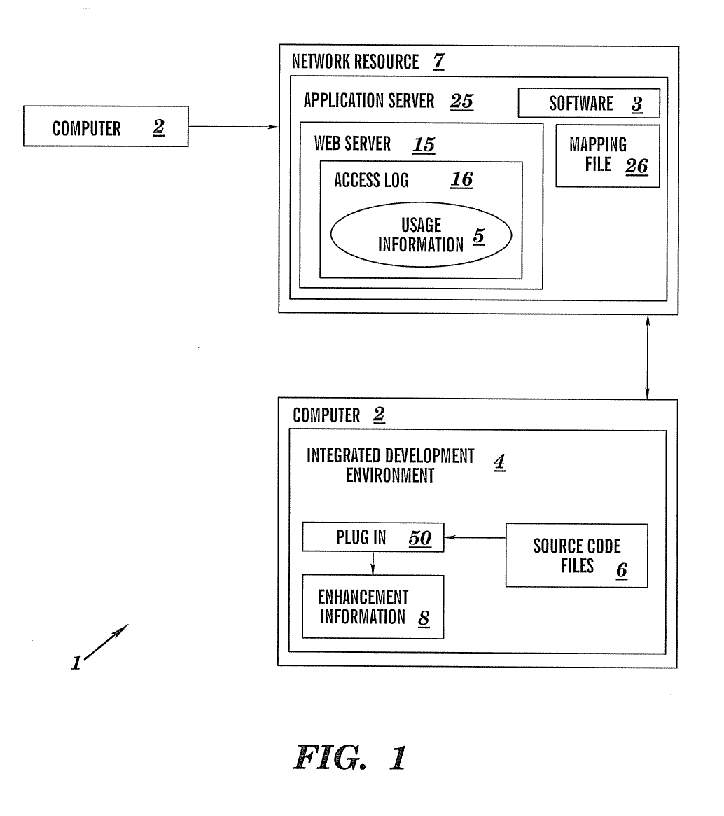

Referring to FIG. 1, there are shown exemplary aspects of a system 1 for providing usage information 5 to an Integrated Development Environment (IDE) 4. The usage information 5 is descriptive of the use of a software product 3 by at least one end-users. The usage information 5 includes content that is useful to developers of the software product 3, in view of developer goals for enhancement, troubleshooting, revision and improvement of the software product 3.

Typically, the IDE 4 includes many resources. However, for simplicity and ease of reference, it is considered that the IDE 4 resides on a computer 2 coupled to machine readable media and executes thereon using machine readable instructions stored on the machine readable media.

In FIG. 1, the end-user operates the software product 3 that includes machine executable instructions stored on machine readable media, such as another computer 2. The software product 3 generates and provides usage information 5 that is descriptive of an end use of the software 3. Typically, the usage information 5 is generated by the software 3 and is typically stored on a network resource 7. In some embodiments, the usage information 5 is generated by a separate component tracking the operations of the software product 3.

In a typical embodiment, the usage information 5 is stored in an access log 16 which is logged by a web server 15. The IDE 4 of the present teachings provides for collection and assimilation of the usage information 5. The collection and assimilation provides enhancement information 8 for the enhancement, troubleshooting, revision and improvement of the software product 3.

The system 1 includes, among other things, source code files 6 for use with the IDE 4. Typically, an Application Server 25 hosts a mapping file 26 and the application code for software 3. The source code files 6 and the access log 16 are related via the mapping file 26 on the Application Server 25.

An exemplary embodiment of the IDE 4 is publicly available and known as “ECLIPSE.” The exemplary IDE 4 is a composition of components, and includes a Rich Client Platform (RCP) that is a subset of the IDE 4. The RCP is used for software development in diverse areas that include banking, automotive, medical, and space exploration and others. As the terminology “rich client” implies, the RCP is a platform for building applications that work in conjunction with application servers, databases, and other backend resources to deliver a rich experience for the end-user.

The exemplary IDE 4 is a base mechanism for discovering, integrating, and running modules called “plug-ins.” Typically, when the IDE 4 is installed, the developer is presented with a set of available plug-ins for augmentation of development tasks.

A plug-in 50 according to the present teachings generally provides for two functions.

In typical embodiments of a first function, the plug-in 50 is installed as a component of the IDE 4, and provides for obtaining by at least one of receipt and retrieval of trace output from various embodiments of the software product 3. Typically, the trace output is obtainable through an HTTP server and application server logs. The plug-in 50 provides for, among other things, sorting of classes (for example, Java code files) by frequency (as identified in the access log 16), and the highlighting of paths for the source code 6 by looking at the parameters passed in on the URL and by looking at the “referrer” information in the access log 16.

In some embodiments involving a second function, the plug-in 50 provides for incorporation of components into the software product 3 to be used by the end-user. The plug-in 50 includes instructions for pointing the mapping file 26 to the access log 16. The plug-in 50 may include instructions for generation, formatting and other aspects of the access log 16.

In some embodiments, the software product 3 provides usage information 5 that is adequate or desired by developers without the aid of plug-in components. In these embodiments, the plug-in 50 provides for at least one of retrieving the usage information 5 and placing the usage information 5 computer 2 used by the IDE 4.

In various embodiments, the mapping file 26 converts a Uniform Resource Locator (URL) request coming in to the Web Server 15 into a path to the source code files 6 that run in support of the URL request.

In some embodiments, the plug-in 50 provides for including components with software products 3 developed using the IDE 4, where the components included in the software provide for software maintains a log of use characteristics as usage information 5. The usage information 5 is typically obtained in the background (i.e., transparently provided) to the Web Server 15 and are at least one of manually obtained, automatically obtained and periodically obtained.

The providing of usage information 5 and translation to enhancement information 8 provides software developers with an understanding of how the software product 3 is being used. Although one log that can be used to provide the information is the access log 16, other logs may be used. For example, another log to take into consideration would include a log created by a servlet filter. With the traces providing the usage information 5, software developers may easily determine what Action class (if using Struts) or what JSP is to be executed. All kinds of other information is also available such as who is making the request, where the request comes from, the response time, date and time of the request, all parameters coming in, whether the request was successful or not, etc.

As used herein, JavaServer Pages (JSP) technology provides techniques and resources for creating dynamic web content. Apache Struts is a web development framework. Using Struts, a servlet (or equivalent) manages business logic execution, and presentation logic resides mainly in server pages.

In a simple and exemplary embodiment, the teachings herein provide for highlighting particular JSP's or ordering the JSP's in a list based on usage. Other embodiments could provide for using other supplied data to highlight or order the JSP's differently. Likewise, in the case of a Struts based application, one would do similar things to parse the Action Classes. Other possibilities include highlighting the code path's most often taken based on incoming parameters (i.e., what buttons where pushed on the browser side and other such information).

The developer would typically be provided with a variety of different information resources. The actual information available to the developer would depend upon, among other things, the logs selected for tracking of the usage information 5. That is, some known logs (such as the HTTP access log 16) provide information of known scope and character. However, other logs could be devised and provide developers with useful information as well. Although disclosed with regard to usage logs, one skilled in the art will recognize that various other forms for the usage information 5 may be had. For example, the action classes, JSPs, and other forms of information may be used.

Access to usage information 5 and enhancement information 8 would provide developers with an understanding of how code is being used. For example, at least one of the usage information 5 and the enhancement information 8 would identify aspects such as paths that are not taken as well as what options are used and not used. Another advantage is that having at least one of usage information 5 and enhancement information 8 gives the developer notice and an understanding of what defects are present and should be fixed. For example, if the developer is provided a list having hundreds of items to work on, being able to graphically see what's most important based off of how the software product 3 is currently being used would provide for appropriate prioritizing of efforts.

Accordingly, one skilled in the art will readily recognize that the plug-in 50 may incorporate a variety of known technology. For example, graphic interfaces may be used in the plug-in 50. Data grouping, assessment and presentation technologies may be used in the plug-in 50. Aspects of the plug-in 50 may be shared between resources, such as computers 2. The plug-in 50 may be provided as a separate software program, independent of the IDE 4, and need not resemble a program add-on at all. The plug-in 50 may be included in another program as a feature thereof. In short, a variety of resources, techniques and strategies are available for implementing the teachings provided herein. Accordingly, the teachings herein provide for these other resources, techniques and strategies as the disclosure herein is merely illustrative of the invention and is not limiting thereof.

At least in some respects, the enhancement information 8 is produced by reading a log including the usage information 5 and then at least one of analyzing, qualifying, characterizing, prioritizing, grouping and displaying the usage information 5. Typically, the plug-in 50 provides the functionality required for the transformation of the usage information 5 into enhancement information 8.

As the teachings herein make reference to a “plug-in,” it should be recognized that the various aspects disclosed as a plug-in are essentially in reference to a computer program product stored on machine readable media, and that the use of the term “plug-in” is merely for convenience and is not limiting of the teachings herein.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media and comprising instructions for providing a developer with enhancement information generated from usage information produced by software, the instructions comprising instructions for:
obtaining a log file comprising usage information from a network resource, the software having stored the usage information as a log file;
reading the log file;
transforming the usage information into the enhancement information; and
providing the enhancement information to the developer.

2. The computer program product as in claim 1, wherein the enhancement information comprises information regarding at least one of paths taken; options used; notice of defects and priority information.

3. The computer program product as in claim 1, wherein the enhancement information comprises information regarding how the software is being used.

4. The computer program product as in claim 1, wherein obtaining comprises at least one of receiving and retrieving.

5. The computer program product as in claim 1, wherein the network resource comprises a web server.

6. The computer program product as in claim 1, wherein the log file comprises at least one of an access log, trace output and an application log file.

7. The computer program product as in claim 1, wherein the product comprises at least one of a plug-in, a feature, and a separate program.

8. The computer program product as in claim 1, wherein the software comprises components of the computer program product for producing the usage information.

9. The computer program product as in claim 1, wherein transforming comprises at least one of analyzing, qualifying, characterizing, prioritizing, grouping and displaying the usage information.

10. The computer program product as in claim 1, wherein providing the enhancement information comprises performing at least one of data grouping, assessment and presentation of the usage information.

11. The computer program product as in claim 1, wherein a mapping file comprises instructions for obtaining the usage information.

12. The computer program product as in claim 1, wherein obtaining comprises at least one of manually, periodically and automatically obtaining.

13. The computer program product as in claim 1, wherein the product comprises a plug-in component for an integrated development environment.

14. A computer program product stored on machine readable media and comprising instructions for providing a developer with enhancement information generated from usage information produced by software, the instructions comprising instructions for:
obtaining a log file comprising usage information from a network resource comprising a web server by at least one of receiving and retrieving the usage information, by referring to a mapping file that comprises instructions for obtaining the usage information;
the software having stored the usage information as the log file where the log file comprises at least one of an access log, trace output and an application log file and where the software comprises components of the computer program product for producing the usage information;
reading the log file;
transforming the usage information by at least one of analyzing, qualifying, characterizing, prioritizing, grouping and displaying the usage information into the enhancement information and performing at least one of data grouping, assessment and presentation of the usage information; and
providing the enhancement information to the developer; wherein the enhancement information comprises information regarding at least one of paths taken; options used; notice of errors and warnings; priority information and information regarding how the software is being used;
wherein the computer program product comprises at least one of a plug-in, a feature, and a separate program.
